(19) United States
(12) Patent Application Publication
(10) Pub. No.: US 2013/0159466 A1
(43) Pub. Date: Jun. 20, 2013

(54) VEHICULAR COMMUNICATION CONTROL APPARATUS

(71) Applicant: DENSO CORPORATION, Kariya-city (JP)

(72) Inventor: Siyao MAO, Kariya-city (JP)

(73) Assignee: DENSO CORPORATION, Kariya-city (JP)

(21) Appl. No.: 13/713,401

(22) Filed: Dec. 13, 2012

(30) Foreign Application Priority Data
Dec. 14, 2011 (JP) 2011-273744

(51) Int. Cl. H04L 29/08

(52) U.S. Cl. CPC H04L 29/08558
USPC 709/218

(57) ABSTRACT

A vehicular communication control apparatus for relaying messages between external tools connected to an IP-based network and an in-vehicle ECU connected an in-vehicle LAN is disclosed. When the apparatus forwards a message from a first external tool to the in-vehicle ECU, the apparatus stores a class of the forwarded message until communication attributed to the forwarded message is ended. Upon receipt of a message from a second external tool, the apparatus determines whether or not an interference is caused by the messages from the first and second external tools, based on the stored class of the massage. When the interference is not caused, the apparatus forwards the message from the second external tool to the in-vehicle electronic control unit.

### CROSS REFERENCE TO RELATED APPLICATION

The present application is based on Japanese Patent Application No. 2011-273744 filed on Dec. 14, 2011, disclosure of which is incorporated herein by reference.

### TECHNICAL FIELD

The present disclosure relates to a vehicular communication control apparatus that is interposed, for relaying a message, between an Internet-protocol-based network (IP-based network) and an in-vehicle local area network (LAN) in order to enable transmission and reception of the message between an external tool connected to the IP-based network and an in-vehicle ECU connected to the in-vehicle LAN.

### BACKGROUND

It is known that a diagnostic tool acting as an external tool is communicably connected to an electronic control system mounted in a vehicle to read abnormal data (diagnosis code) or the like from the electronic control system etc. That is, the electronic control system is provided with an interface for establishing a connection with the external tool. For example, Patent document 1 discloses that the external tool performs communications such as message transmission and reception with the electronic control system in accordance with a CAN protocol and reads a necessary data such as a diagnosis code from the electronic control system.

Patent Documents 2 and 3 disclose that a program rewriting tool acting as an external tool is connected to an electronic control system to rewrite a control program stored in a flash ROM etc.
Patent Document 1: JP-2003-318996A (US 2003/0200344A)
Patent Document 2: JP-H9-128229A
Patent Document 3: JP-H11-203115A

In recent years, the number of electronic control systems mounted in a vehicle is increasing. Additionally, the number of functions of each electronic control system, the storage volume or the like is increasing. Moreover, it is expected to rapidly increase the volume of the data transferred from and to the external tool. Therefore, for more efficient communications between an in-vehicle electronic control system and an external tool, the inventor of the present application has studied the use of the same communication standard (Internet protocol: IP) as in a computer network.

The standard (e.g., Diagnostics over Internet protocol: DoIP) for communications between an in-vehicle electronic control system and an external tool is, for example, given by ISO13400. In this DoIP, the external tool communicates with an in-vehicle electronic control unit (ECU) on an in-vehicle LAN via the Ethernet (registered trademark), which is an IP-based network. A communication protocol such as CAN and LIN is used in the in-vehicle LAN, and the communications protocols inside and outside the vehicle are different. Thus, a vehicular communication control apparatus (DoIP gateway) for relaying messages is interposed between a network inside the vehicle and a network outside the vehicle.

Here, when the DoIP is supported, it is possible to simultaneously connect multiple external tools to the network outside the vehicle. Therefore, the multiple external tools may transmit different operation request messages to the same in-vehicle ECU at the same time. When the DoIP gateway forwards respective messages to the in-vehicle ECU, an interference of operations of the in-vehicle ECU may arise depending on classes of messages from the external tools.

For example, let us consider a situation where an external tool A transmits a message to the in-vehicle ECU to request a rewriting of a control program and data and another external tool B transmits a data writing request message, which is different from the message transmitted from the external tool A, to the in-vehicle ECU. In this situation, when the in-vehicle ECU performs the operations in response to both messages, the control program rewritten by the external tool A executes a control that is based on a data written by the external tool B. As a result, the control may not be appropriately executed.

As another example, let us consider a situation where, while the external tool A transmits a message to the in-vehicle ECU to request a rewriting of a control program and data, the external tool B transmits a reset request message to the same in-vehicle ECU. In this situation, the in-vehicle ECU may be reset in the middle of the rewriting of the control program and data by the external tool A, and as a result, the rewriting may not be normally executed.

As yet another example, let us consider a situation where, in order to execute a failure diagnosis of the in-vehicle electronic control system, the external tool A transmits a message to acquire a first data and a second data that were recorded by the in-vehicle ECU at a time of abnormality detection. In the above, the first data and the second data are related to each other, and contents of both the first data and the second data can correctly tell a failure and a fault of the in-vehicle electronic control system. In this situation, it is assumed that another external tool B, which is communicating with the same in-vehicle ECU, transmits a message to the in-vehicle ECU to request the in-vehicle ECU to delete a stored data after acquiring a required data. In this case, when the data deletion in response to the message from the external tool B is performed in the middle of acquiring a series of data by the external tool A, the external tool A may acquire the first data before the data deletion and the second data after the data deletion, for example. Accordingly, the first data and the second data acquired by the external tool A may hot have consistency. The failure diagnosis cannot be performed based on these data in an appropriate way. Further, from the series of inconsistent data acquired by the external tool A, the in-vehicle ECU may be wrongly determined as having a failure.

### SUMMARY

In view of the foregoing, it is an object of the present disclosure to provide a vehicular communication control apparatus that, even when multiple external tools are connected to a network outside a vehicle, can prevent messages from the external tools from causing an interference of operations of an in-vehicle ECU.

According to a first example of the present disclosure, a vehicular communication control apparatus, which is interposed, for relaying messages, between an Internet-protocol-based network and an in-vehicle local area network in order to enable transmission and reception of the messages between external tools connected to the Internet-protocol-based network and an in-vehicle electronic control unit (ECU) connected to the in-vehicle local area network, may comprise a forwarding section (forwarding means), a storing section (storing means), and an interference determination section (interference determination section means). The forwarding section is provided to forward the messages to the in-vehicle ECU that is to receive the messages, upon receipt of the messages from the external tools. The storing section is provided store a class of a message from the first external tool when the forwarding section forwards the message from the first external tool to the in-vehicle ECU. The storing section stores the class of the message from the first external tool until communication, which is between the first external tool and the in-vehicle ECU and is attributed to the message from the first external tool, is ended. When the vehicular communication control apparatus receives a message addressed to the in-vehicle ECU from the second external tool while the in-vehicle ECU is communicating with the first external tool, the interference determination section makes a determination as to whether or not an interference of operations of the in-vehicle ECU is caused by the message from the second external tool and the message whose class is stored by the storing section, based on a class of the message from the second external tool and the class of the message stored by the storing section. When the interference determination section determines that the interference of operations of the in-vehicle ECU is not caused, the forwarding section forwards the message from the second external tool to the in-vehicle ECU.

According to the above vehicular communication control apparatus, when the message from the first external tool is received and forwarded to the in-vehicle ECU and the communication is started, the class of the forwarded message is stored by the storing section until the communication is ended. Because of this, upon receipt of a massage addressed to the same in-vehicle ECU from the second external tool after the receipt of the message from the first external tool, the interference determination section can determine whether the interference of operations of the in-vehicle ECU is caused by both of the messages. When it is determined that the interference of operations of the in-vehicle ECU is not caused, the forwarding section can forward the message from the second external tool to the in-vehicle ECU. Therefore, it becomes possible to prevent the interference of operations of the in-vehicle ECU. Moreover, when the in-vehicle ECU is communicating with a certain tool for example, a message from a different tool 1-n is transmitted to the ECU as long as the transmission of the message from the different tool does not cause the interference of operations of the destination ECU. Therefore, the communications between the external tools and the in-vehicle ECU are efficient, as compared with cases where: when the in-vehicle ECU 1-m is communicating with a certain tool, the transmitting of a request message from a different tool is uniformly prohibited.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram illustrating a structure of an overall system for communications via a DoIP gateway;

FIG. 2 is a functional block diagram illustrating a DoIP gateway;

FIG. 3 is a diagram illustrating an interference definition information table;

FIG. 4 is a diagram illustrating a structure of communication state information managed by a communication state management section;

FIG. 5 is a flowchart illustrating an interference determination process performed by a DoIP gateway when the DoIP gateway receives a request message from a tool;

FIG. 6 is a flowchart illustrating an update process to update communication state information;

FIG. 7 is a diagram showing an example of preventing an operation interference in an ECU by performing the processes in FIGS. 5 and 6;

FIG. 8 is a diagram illustrating a structure of communication state information, which is provided to implement a message suspend function of a second embodiment;

FIG. 9 is a flowchart illustrating an interference determination process of the second embodiment;

FIG. 10 is a flowchart illustrating details of an interference information setting at S906 of FIG. 9; and

FIG. 11 is a flowchart illustrating an update process of the second embodiment to update communication state information.

### DETAILED DESCRIPTION

### First Embodiment

A vehicular communication control apparatus of a first embodiment will be described with reference to the drawings. In the present embodiment, the vehicular communication control apparatus is embodied as a DoIP gateway.

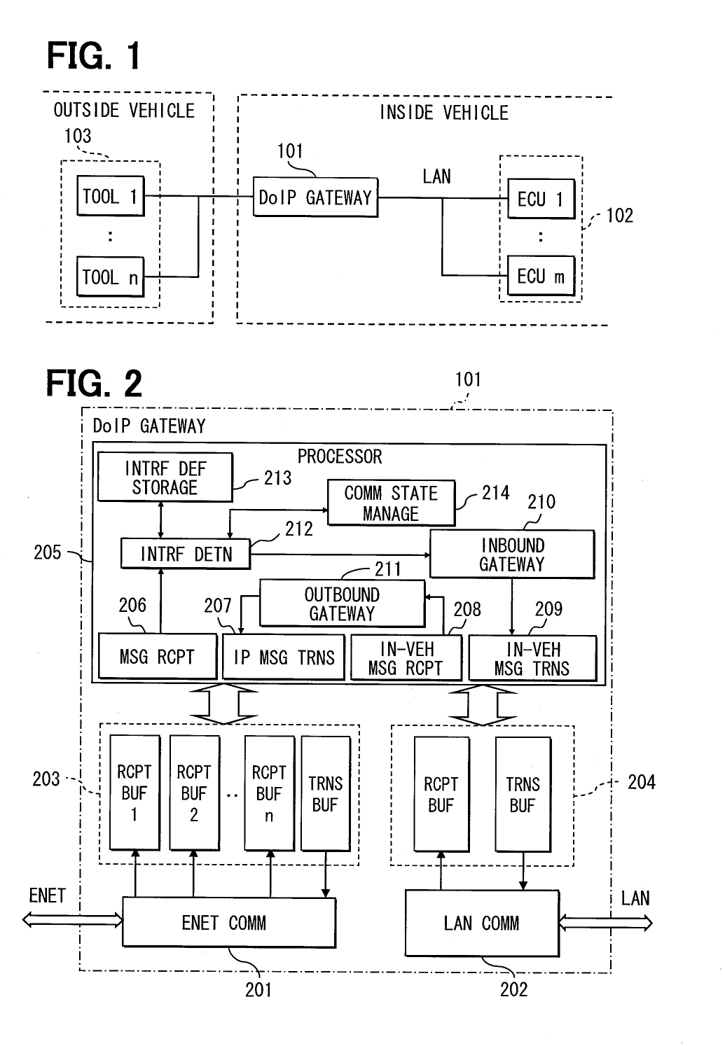

FIG. 1 shows a structure of an overall system for communications via the DoIP gateway 101. In this system, the DoIP gateway 101 is installed in a vehicle and connected to a local area network (LAN) in the vehicle. At least one in-vehicle ECU 102 (ECU 1-m) is connected to this in-vehicle LAN. Therefore, the DoIP gateway 101 is capable of communicating with the in-vehicle ECU 102 via the in-vehicle LAN. A communication protocol of in-vehicle LAN may be CAN, LIN, etc.

The DoIP gateway 101 is connected to at least one external tool 103 (tool 1-n) outside the vehicle via an Ethernet, which is an IP-based network. The Ethernet and DoIP gateway 101 may be connected in a wired manner or a wireless manner.

The Ethernet uses the DoIP (Diagnostics on Internet protocol), which is defined by ISO13400, as its communication protocol. The in-vehicle LAN uses CAN, LIN or the like as its communication protocol. Thus, the communication protocols of the networks inside and outside the vehicle are different from each other. When the DoIP gateway 101 forwards messages from the external tool 103 to the in-vehicle ECU 102 or from the in-vehicle ECU 102 to the external tool 103, the DoIP gateway 101 performs protocol translation of the messages. Such message forwarding with the protocol translation is also referred to herein as a gateway operation.

Through performing message exchange with the in-vehicle ECU 102, the external tool 103 can read a diagnosis code and an internal data from the in-vehicle ECU 102 and reset the in-vehicle ECU 102. The external tool 103 may update a control program in the in-vehicle ECU 102 by rewriting the control program or writing and deleting a data. Such an external tool 103 may be provided with hardware or software that is capable of performing DoIP communications with the in-vehicle ECU 102.

Next, with reference to FIG. 2, functions of the DoIP gateway 101 will be described. FIG. 2 is a functional block diagram of the DoIP gateway 101.

As shown in FIG. 2, in order to perform communications via the Ethernet, the DoIP gateway 101 includes an Ethernet communications section 201 and a buffer 203. The buffer 203 is provided to store messages, which the Ethernet communications section 201 transmits and receives. In order to perform communications via the in-vehicle LAN, the DoIP gateway 101 includes a local-network communications section 202 and a buffer 204. The buffer 204 is provided to store messages transmitted and received in the vehicle. The DoIP gateway 101 further includes a gateway processor 205 for implementing a gateway function between the buffer 203 for the Ethernet and the buffer 204 for the in-vehicle LAN.

An IP message reception section 206 and an IP message transmission section 207 are provided in the gateway processor 205 to receive and transmit DoIP messages. The IP message reception section 206 and IP message transmission section 207 exchange the received and transmitted messages with the buffer 203 for Ethernet. An in-vehicle message reception section 208 and an in-vehicle message transmission section 209 are provided in the gateway processor 205 to transmit and receive messages on the in-vehicle LAN. The in-vehicle message reception section 208 and in-vehicle message transmission section 209 exchange the received and transmitted messages with the buffer 204 for the in-vehicle LAN.

An inbound gateway section 210 (also called herein a vehicle-outside-to-vehicle-inside gateway operation section) is provided between the IP message reception section 206 and in-vehicle message transmission section 209. An outbound gateway section 211 (also called herein a vehicle-inside-to-vehicle-outside gateway operation section) is provided between the IP message transmission section 207 and in-vehicle message reception section 208. The inbound gateway section 210 translates (i) a communication protocol and (ii) an address of a request message because the translation is needed to perform the gateway operation of forwarding the request message to the in-vehicle ECU 102. The outbound gateway section 211 translates a communication protocol and an address of a request message because the translation is needed to perform the gateway operation of forwarding the request message to the external tool 103.

An interference determination section 212 is provided between the IP message reception section 206 and the inbound gateway section 210. When the multiple external tools 103 (tools 1-n) simultaneously transmit request messages addressed to the same one ECU 1-m, the interference determination section 212 determines whether an interference of operations of the ECU 1-m is caused by the request messages. When the interference determination section 212 determines that the interference of operations is not caused, the interference determination section 212 transmits the request messages to the inbound gateway section 210 to perform the gateway operation of forwarding the request message to the destination ECU 1-m. When the interference determination section 212 determines that the interference is caused, the interference determination section 212 does not output the request message to the inbound gateway section 210, thereby preventing the gateway operation of forwarding the request message to the destination ECU 1-m.

In the above case, the interference determination section 212 instructs a response message outputting section (not shown in FIG. 2) to output a negative-acknowledgement response message, which indicates rejection of the receipt. When this negative-acknowledgement response message is transmitted via the Ethernet communications section 201 to the tool 1-n that has transmitted the request message, an operator operating the tool 1-n can understand that the receipt of the request message from the tool 1-n was rejected, and thus, the operator can, for example, again instruct the tool 1-n to transmit the request message after the communications with another other tool 1-n is ended. When the interference determination section 212 determines that the interference in the destination ECU 1-m does not arise, the interference determination section 212 instructs the response message outputting section to output an acknowledgment response message indicating acknowledgement of receipt of the request message.

The interference determination section 212 make a determination as to the above interference with reference to an interference definition information table stored in an interference definition information storage 213 and communication state information stored in a communication state management section 214. The communication state information includes information associated with a communication state between each ECU 1-m (each in-vehicle ECU 102) and each tool 1-n (the external tool 103).

The interference definition information table includes information about whether a combination of a class of an early-received request massage and a class of a later-received request message causes an interference of operations of a destination ECU 1-m. Since the class of request message to be transmitted from each tool 1-n to each destination ECU 1-m is known in advance, it can be determined in advance what combination of classes of request messages causes an interference of operations of a destination ECU 1-m.

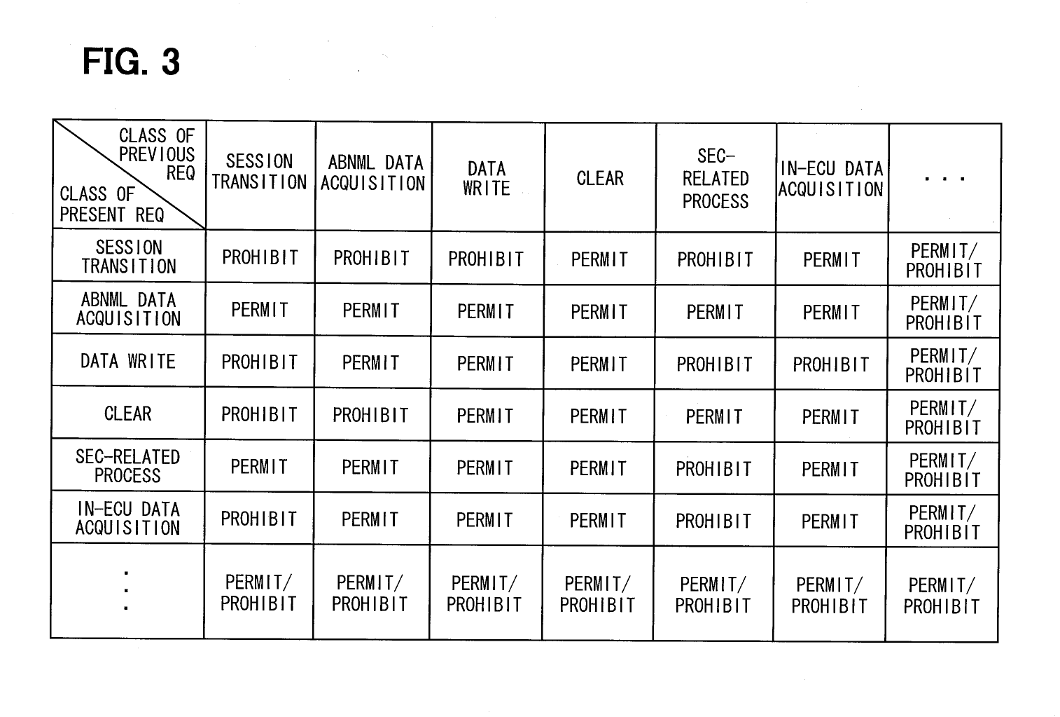

FIG. 3 is a diagram illustrating an example of the interference definition information table. Classes of all diagnosis request messages supported by each ECU 1-m connectable to the DoIP gateway 101 are registered in the interference definition information table. In the interference definition information table, a class of a previous request message is a class of request message received the previous time, and a class of a present request message is a class of request message received this time. For each combination of the class of a present request message and the class of a previous request message, “permission” or “prohibition” is predefined. The prohibition means that a later-received request message causes a destination ECU 1-m, which is performing the communication attributed to a previously received request message, to have the operation interference with the previously received request message.

As described in Background section with reference to exemplary cases, the interference may mean situations where the ECU 1-m cannot properly operate or the acquisition of a desired data from the ECU 1-m ends up in fail. The definition of the interference varies depending on vehicle functions and topology of the in-vehicle LAN, and permission and prohibition to execute a request message should be determined in consideration of vehicle safety and data integrity. For example, let us assume a situation where, as a security-related process, the tool 1 transmits a request message requesting disarm of security of the ECU 1, and as a result, the ECU 1 disarms the security. In the above situation, the tool 2 may transmit, to the same ECU 1, a request message to acquire a data inside the ECU 1. In this case, the ECU 1 and the tools 1 and 2 simultaneously execute these two requests, and the tool 2 may acquire, by taking advantage of the security-disarmed state of the ECU, the ECU-inside data that is prohibited from being provided to the tool 2. Therefore, by deeming that the above situation is the operation interference in the ECU 1-m, the interference definition information table shown in FIG. 3 prohibits the tool 2 from acquiring the ECU-inside-data while the tool 1 is executing a security-related process and communicating with the ECU 1.

The “session transition” in FIG. 3 means that a range of classes of messages that are requestable from the tool 1-n to the ECU 1-m is changed. For example, a certain tool 1-n may be set so that the certain tool 1-n is prohibited from transmitting a session transition request message, which is a message requesting the session transition. In that case, the certain tool 1-n can acquire only response messages corresponding to request messages in a limited range (e.g., abnormal data acquisition request message) from the ECU 1-m (the ECU 1-m does not respond to request messages out of the limited range). A different tool 1-n may be set so that the different tool 1-n is permitted to transmit the session transition request message. When the session transition request message is transmitted to the ECU 1-m, the ECU 1-m transits into a state where the ECU 1-m receives all request messages and transmits response messages. In the above, three or more levels may be settable as the range of requestable messages.

The session transition request may be used together with a security disarm request. Authentication by a password is typically required for the security disarm request. Because of this, by permitting the session transition only in a security-disarmed state, it becomes possible to permit only an authorized operator to execute important processes such as data writing or the like.

Next, the communication state information managed by the communication state management section 214 will be described.

As shown in FIG. 1, the multiple tools 1-n serving as the external tools 103 may be connected to the Ethernet, and the multiple ECUs 1-m serving as the in-vehicle ECUs 102 may be connected to the in-vehicle LAN. Therefore, the DoIP gateway 101 may simultaneously receive request messages addressed to the same ECU 1-m from the multiple tools 1-n. For a determination as to an N-M communications interference between the tools 1-n and ECUs 1-m, the communication state management section 214 manages the below-described information as the communication state information.

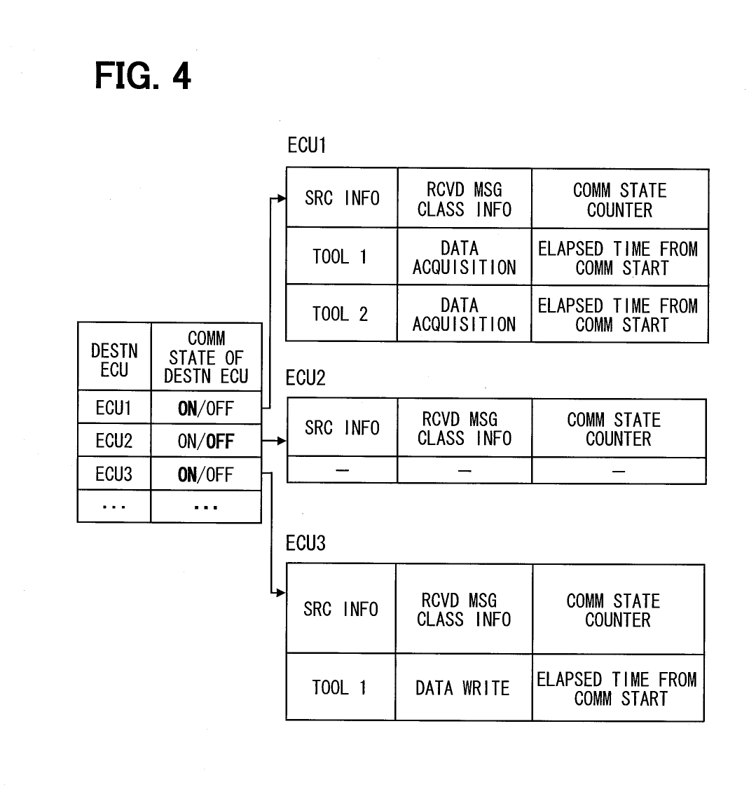

As shown in the left side of FIG. 4, the communication state management section 214 has a “communication state of a destination ECU” for each ECU 1-m. This communication state shows whether or not the each ECU 1-m is communicating with at least one tool 1-n. In the example shown in FIG. 4, ON and OFF represent whether or not each ECU 1-m is communicating.

As shown in the right side of FIG. 4, for each ECU 1-m with the ON communication state, the communication state management section 214 has source informations, received message class informations, and communication state counters for all of tools 1-n that are communicating with the each ECU 1-m.

The received message class information is used as a basis for making the determination as to the interference, as illustrated in FIG. 3. When request messages from the tools 1-n are forwarded to the destination ECU 1-m and the tools 1-n start communicating with the destination ECU 1-m, the communication state counter counts a time elapsed from the start of each communication. That is, the communication state counter provides information indicating a time elapsed since the destination ECU 1-m starts the communication with each tool 1-n. Based on an elapsed time counted by this communication state counter, it is determined whether the communication between each tool 1-n and ECU 1-m is in operation or is ended (completed). Therefore, when a new request message is received from the tool 1-n, the corresponding communication state counter is reset and then starts counting up. When there has been no receipt of the request message addressed to the same ECU 1-m from the same tool 1-n during a predetermined time, the communication state counter times out and enters an idle state. The information (e.g., the source information and the received-message class information) of the tool 1-n corresponding to the idle-state communication state counter is deleted from the communication state information. This is because, when the predetermined time has elapsed since the start of the communication, the communication due to the request message from the tool 1-n is deemed ended.

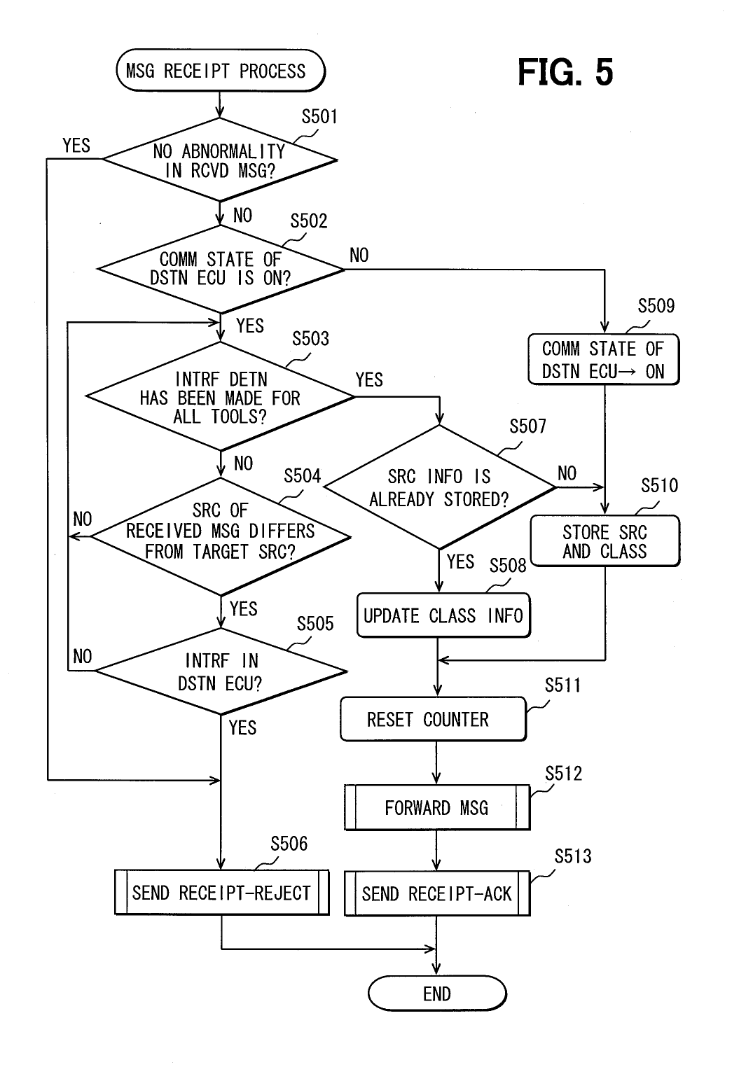

Next, an interference determination process will be described with reference to the flowchart of FIG. 5. The DoIP gateway 101 performs the interference determination process upon receipt of a request message from a tool 1-n

First, at S501, upon receipt of a request message from any tool 1-n, DoIP gateway 101 checks the request message and determines whether a header, a payload, a message length, etc. of the request message satisfies a protocol defined by ISO13400-2. When a protocol abnormality is present in the received request message, the process proceeds to S506 where the DoIP gateway 101 transmits a negative-acknowledgement response message. When the request message has no abnormality, the process proceeds to S502.

At S502, the DoIP gateway 101 determines a communication state of a destination ECU 1-m, which is a destination of the request message, based on the above-described communication state of the destination ECU. In this determination, when it is determined that the communication state of the destination ECU 1-m associated with the request message is OFF, the process proceeds to S509. At S509, the communication state of the destination ECU 1-m is changed to ON. At S510, the source information indicating which tool 1-n has transmitted the request message and the received message class information indicating the class of the request message are stored as the communication state information.

When it is determined at S502 that the communication state of the destination ECU 1-m is ON, the process proceeds to S503. In this case, the destination ECU 1-m is communicating with at least one tool 1-n. Therefore, at S503 to S505, for all of the tools 1-n communicating with the destination ECU 1-m, it is sequentially determined whether a combination of a class of the present request message and a class of a communicating request message (i.e., the previous request message) causes the interference of operations of the destination ECU 1-m. Specifically, at S503, it is determined whether the determination as to the interference of operations has been made for all of the tools 1-n that are communicating with the destination ECU 1-m and acting as the sources. When the determination as to the interference of operations has not been made for all of the communicating source tools 1-n, a target tool is selected and the process proceeds to S504. Here, the target tool is the tool 1-n for which the determination as to the interference of operations has not been made. When the determination as to the interference of operations has made for all of the communicating source tools 1-n, the process proceeds to S507.

At S504, it is determined whether the target tool 1-n, for which the determination at to the interference has not been made, is different from the tool 1-n that is a source of the present request message (i.e., the request message received this time). It should be noted that when the target tool 1-n is the same as the source of the present request message, the request message causing the interference of operations is not transmitted. Therefore, when t when the target tool 1-n is the same as the source of the present request message (No at S504), the process returns to S503. When the target tool 1-n is different from the source of the present request message (YES at S504), the process proceeds to S505.

At S505, with reference to the interference definition information table, it is determined whether the interference of operations arises in the destination ECU 1-m, based on a class of the present request message and a class of the request message that was received from the target tool 1-n. When it is determined that the interference of operations arises, the process proceeds to S506. At S506, the DoIP gateway 101 transmits the negative-acknowledgement response message indicating the rejection of the receipt of the request message. Because of this, when, out of the tools 1-n communicating with the destination ECU 1-m, there is a tool 1-n that has transmitted the request message causing the interference of operations in the destination ECU 1-m in combination with the present request message, the present request message is rejected, and the negative-acknowledgement response message is returned to the tool 1-n that has transmitted the present request message. On the other hand, when it is determined that interference of operations does not arise, the process returns S503 to determine whether there remains the tool 1-n for which the determination as to the interference of operations has not been made.

When the DoIP gateway 101 does not transmit the negative-acknowledgement response message at S506 and the DoIP gateway 101 determines at S503 that the determination as to the interference of operations has been made for all the communicating tools 1-n, the process proceeds to S507. At S507, it is determined whether the information about the tool 1-n which is the source of the present request message is already stored as the source information. That is, it is determined whether the tool 1-n, which has transmitted the present request message, had transmitted another request message to the destination ECU 1-m prior to the transmitting the present request message, and it is determined whether the communication state information of the tool 1, which has transmitted the present request message, is already registered.

When a result of the determination at S507 is “Yes,” the process proceeds to S508, because the source information about the tool 1-n is already stored in the communication state information. At S508, the received message class information, which indicates the class of the request message, is updated based on a class of the received request message. This is done for preparation for (i) start of communication attributed to a newly-received request message between the destination ECU 1-m and a tool 1-n transmitting the newly received request message, and for (ii) making the determination as to the interference of operations between the newly received request message and a request message received later than the newly received request message. When a result of the determination at S507 is “No,” the process proceeds to S510. At S510, the DoIP gateway 101 stores (i) the source information indicating a new tool 1-n that has transmitted the request message and (ii) the received-message class information indicating the class of the request message.

At S511, the DoIP gateway 101 resets the communication state counter associated with the request message updated at S508 or stored at S510, and DoIP gateway 101 causes the communication state counter to start counting. At S512, the DoIP gateway 101 performs the gateway operation of forwarding the request message to the destination ECU 1-m. At S513, an acknowledgment response message indicating the acknowledgment of the receipt of the request message is transmitted to the tool 1-n that has transmitted the request message.

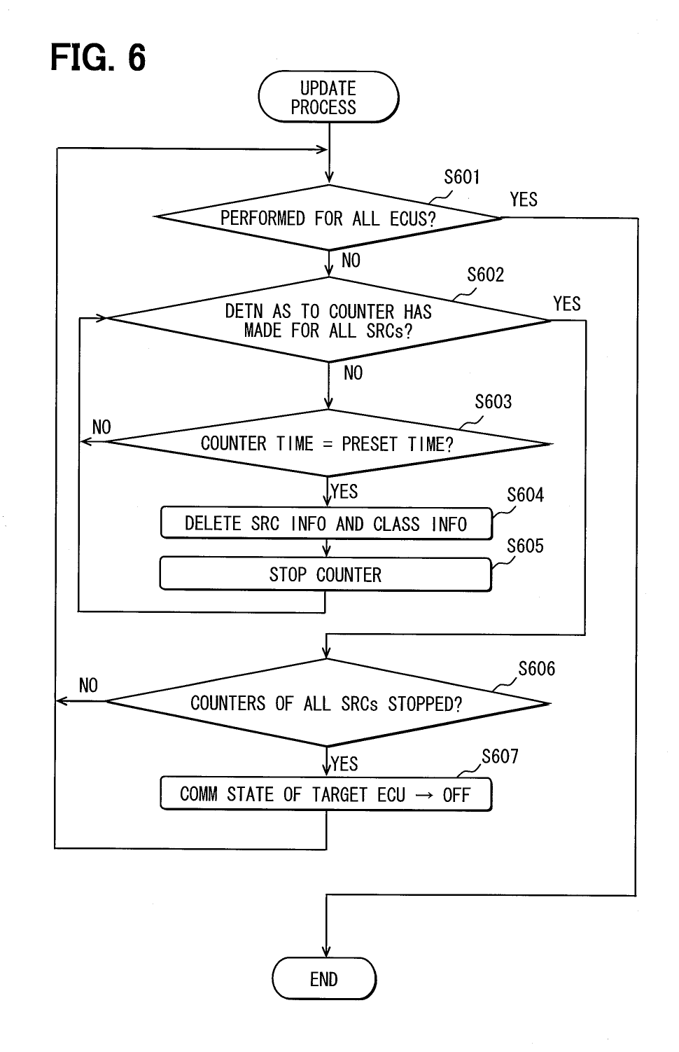

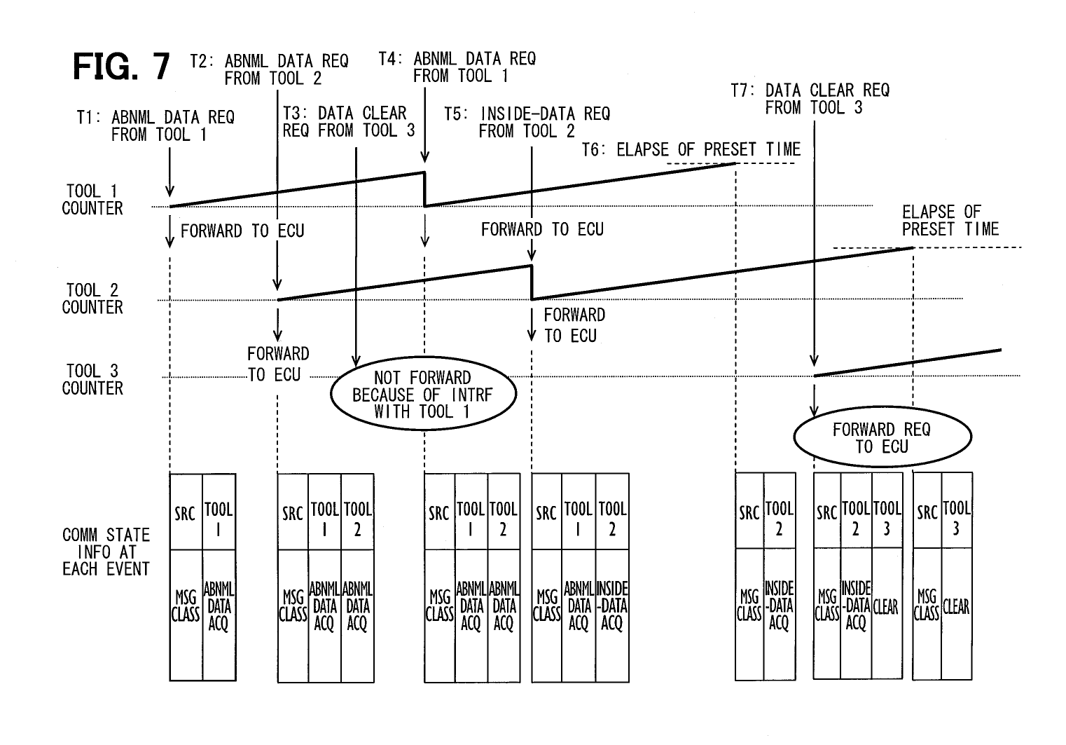

Next, an update process for updating the communication state information will be described with reference to the flowchart of FIG. 6. The update process is periodically performed. For example, the update process is periodically performed every time a predetermined period has elapsed.

At S601, it is determined whether or not S602 to S607 have been performed for all of the ECUs 1-m having the ON communication state. When it is determined at S601 that the S602 to S607 have not been performed for all of the ECUs 1-m having the ON communication state, one ECU 1-m for which S602 to S607 have not been performed is selected as a target ECU 1-m, S602 to S607 are performed for the target ECU m-1. In this way, S602 to S607 are performed for the ON-communication-state ECUs 1-m in turn on a ECU-by-ECU basis. When it is determined at S601 that S602 to S607 have been performed for all of the ON-communication-state ECUs 1-m, the update process in FIG. 6 is ended.

At S602, it is determined whether a determination at S603 has been made for all of the communication state counters contained in the communication state information of the target ECU 1-m. When it is determined that the determination at S603 has not been made for all of the communication state counters contained in the communication state information of the destination ECU 1-m, the DoIP gateway 101 selects a target communication counter from the communication state counters for which the determination at S603 has not been made, and the process proceeds to S603. At S603, it is determined whether an elapsed time, which is counted by the target communication state counter, from the start of the communication reaches a predetermined time.

As mentioned above, upon receipt of another request message (new request message) from the same tool 1-n, the communication state counter is reset and starts counting (see S511 of the flowchart of FIG. 5). Therefore, when (i) the predetermined time has elapsed since the request message was received from the tool 1-n and (ii) there has been no receipt of the new request message from the same tool 1-n, the elapsed time counted by the communication state counter reaches the predetermined time. In this embodiment, the predetermined time is set to a time period equal to or longer than a time period required for the communication between the tool 1-n and the ECU 1-m, where the communication is the communication attributed to a request message from the tool 1-n.

At S603, when it is determined that the elapsed time counted by the communication state counter reaches the predetermined time, the communication with the tool 1-n corresponding to the target communication state counter is deemed ended, and the process proceeds to S604. At S604, the source information indicative of the tool 1-n corresponding to the target communication state counter and the class information indicative of the class of the request message are deleted from the communication state information. At S605, the elapsed time counted by the communication state counter is deleted, and additionally, the communication state counter stops counting.

After cyclically performing S603 to S605 in the above way, the DoIP gateway 101 eventually determines at S602 that the determination at S603 has been made for all of the communication state counters contained in the communication state information of the target ECU 1-m, and then, the process proceeds to S606. At S606, it is determined whether all of the communication state counters in the communication state information of the target ECU 1-m have stopped counting. When all of the communication state counters in the communication state information of the target ECU 1-m have stopped counting, the target ECU 1-m is deemed not communicating with any one of the tools 1-n. Therefore, at S607, the communication state of the target ECU 1-m is set to OFF. Then, S601 is again performed to check whether there remains the ECU 1-m for which the determination at S602 has not been made.

By performing the update process illustrated in FIG. 6, it is possible to correctly update the communication state information and store only the information about the tools 1-n that are actually communicating with each ECU 1-m.

Next, with reference to FIG. 7, a specific example of preventing the interference of operations of the ECU 1-m by the processes illustrated in FIGS. 5 and 6 will be described. FIG. 7 illustrates the example in which the tools 1-3 simultaneously communicate with the same ECU 1-m (with their communication periods overlapping).

At a time T1, the DoIP gateway 101 receives an abnormal data acquisition request message from the tool 1. In response, the DoIP gateway 101 stores the source information, which indicates that the tool 1 is the source of the request message, and the class information, which indicates the class of the request message. Additionally, the DoIP gateway 101 performs the gateway operation of forwarding the request message to a destination ECU 1-m (target ECU). At the same time, the communication state counter corresponding to the tool 1 starts counting an elapsed time.

At a time T2, the DoIP gateway 101 receives a request message for abnormal data acquisition from tool 2, where the tool 1 is communicating with the destination ECU 1-m. In response, the DoIP gateway 101 determines whether the request message from the tool 2 causes an interference of operations of the destination ECU 1-m in combination with the request message from the tool 1 based on the classes of the two request messages with reference to the interference definition information table. In this case, since the classes of the two request messages are abnormal data acquisition requests, the two request messages cause no interference of operations in the destination ECU 1-m. Therefore, the DoIP gateway 101 stores the source information indicative of the tool 2 and the class information indicative of the class of the request message from the tool 2, and then performs the gateway operation of forwarding the request message to the destination ECU 1-m. At the same time, the communication state counter corresponding to the tool 2 starts counting a time elapsed.

At a time T3, the DoIP gateway 101 receives a data clearance request message from the tool 3, the DoIP gateway 101 determines whether the request message from the tool 3 in combination with the request messages from the tools 1 and 2 causes the interference of operations in the destination ECU 1-m. In this case, by referring to the interference definition information table, the DoIP gateway 101 determines that the data clear request in combination with the abnormal data acquisition request causes the interference of operations of the ECU 1-m. Therefore, the DoIP gateway 101 does not perform the gateway operation of forwarding the request message from the tool to the destination ECU 1-m. In stead, the DoIP gateway 101 transmits, to the tool 3, a negative-acknowledgement response message indicating that reception of the request message is rejected.

At a time T4, the DoIP gateway 101 receives an abnormal data acquisition request message from the tool 1 again. In this case, since this abnormal data acquisition request message in combination with the abnormal data acquisition request message from the tool 2, where the tool 2 is communicating with the destination ECU 1-m, causes no interference of operations of the destination ECU 1-m, the DoIP gateway 101 (i) updates the class information, which is indicative of the class of the request message and is included in the communication state information, and (ii) performs the gateway operation of forwarding the request message to the destination ECU 1-m. Further, the communication state counter of the communication state information is reset and newly starts counting the elapsed time.

At a time T5, the DoIP gateway 101 receives an internal data acquisition request message from the tool 2. In this case, since the internal data acquisition request message in combination with the abnormal data acquisition request message from the tool 1, where the tool 1 is communicating with the destination ECU 1-m, causes no interference of operations in the destination ECU 1-m, the DoIP gateway 101 (i) updates the class information, which is indicative of the class of the request message and is included in the communication state information (the DoIP gateway 101 changes the class of the request message from the abnormal data acquisition request to the ECU-inside data acquisition request), (ii) performs the gateway operation of forwarding the request message to the destination ECU 1-m, (iii) resets the communication state counter of the communication state information, and (iv) causes the communication state counter to start counting the elapsed time.

At a time T6, the elapsed time counted by the communication state counter corresponding to the tool 1 reaches a predetermined time. In response, the source information indicative of the tool 1 and the class information indicative of the class of the request message are deleted from the communication state information. Further, the elapsed time counted by the communication state counter corresponding to the tool 1 is also deleted and the communication state counter stops counting.

At a time T7, the DoIP gateway 101 receives a data clearance request message from the tool 3. At this point, only the tool 2 is communicating. The DoIP gateway 101 determines whether the request message from the tool 3 in combination with the request message from the tool 2 causes the interference of operations of the ECU 1-m. Since the interference definition information table shows that the data clear request in combination with the inside data acquisition request causes no interference of operations of the ECU 1-m, the DoIP gateway 101 stores the source information indicative of the tool 3 and the class information indicative of the class of the request message, and performs the gateway operation of forwarding the request message from the tool 3 to the destination ECU 1-m. At the same time, the communication state counter corresponding to the tool 3 starts counting the elapsed time.

As can been in the above, when the DoIP gateway 101 of this embodiment receives a request message from one tool 1-n and performs the gateway operation of forwarding the request message to the destination ECU 1-m to let the communication get started, the source information indicative of the tool 1-n and the class information indicative of the class of the request message is stored as the communication state information until the communication attributed to the request message is ended. Because of the storing of the communication state information, when a request message addressed to the same destination ECU 1-m (the same destination ECU) is received from a different tool 1-n, the DoIP gateway 101 can determine whether the two request messages cause the interference of operations in the destination ECU 1-m. Only when the DoIP gateway 101 determines that the interference of operations of the destination ECU 1-m is caused, the DoIP gateway 101 performs the gateway operation of forwarding the request message from the different tool 1-n to the destination ECU 1-m. Therefore, the interference of operations of the destination ECU 1-m is prevented. Moreover, when the destination ECU 1-m is communicating with a certain tool 1-n, a request message from a different tool 1-n is transmitted to the destination ECU 1-m as long as the transmission of the request message from the different tool 1-n does not cause the interference of operations of the destination ECU 1-m. Therefore, the communications between the multiple tools 1-n and the ECUs 1-m are efficient, as compared with cases where: when the destination ECU 1-m is communicating with a certain tool 1-n, the transmitting of a request message from a different tool 1-n is prohibited.

### Second Embodiment

Now, a vehicular communication control apparatus of a second embodiment will be described. The vehicular communication control apparatus of the second embodiment is also embodied as a DoIP gateway.

In the first embodiment, when it is determined that a later-received request message causes the interference of operations of the destination ECU in combination with a previously-received request message which caused the start of the communication, the receipt of the later-received request message is rejected and the negative-acknowledgement response message is transmitted.

In the second embodiment, when it is determined that a later-received request message causes the interference of operations of the destination ECU in combination with a previously-received request message, the DoIP gateway 101 temporarily stores (retains) the later-received request message. Then, after all of the communications attributed to the request messages that can cause the interference of operations are ended, the DoIP gateway 101 performs the gateway operation of forwarding the temporarily-stored (retained) request message to the destination ECU 1-m. This is called herein a message suspend function. According to the message suspend function, after there is transition to a situation in which a certain request message causes no interference of operations of the destination ECU 1-m, this certain request message is automatically transmitted to the destination ECU 1-m. Therefore, a time and effort for the tool 1-n to again transmit the same message can be eliminated.

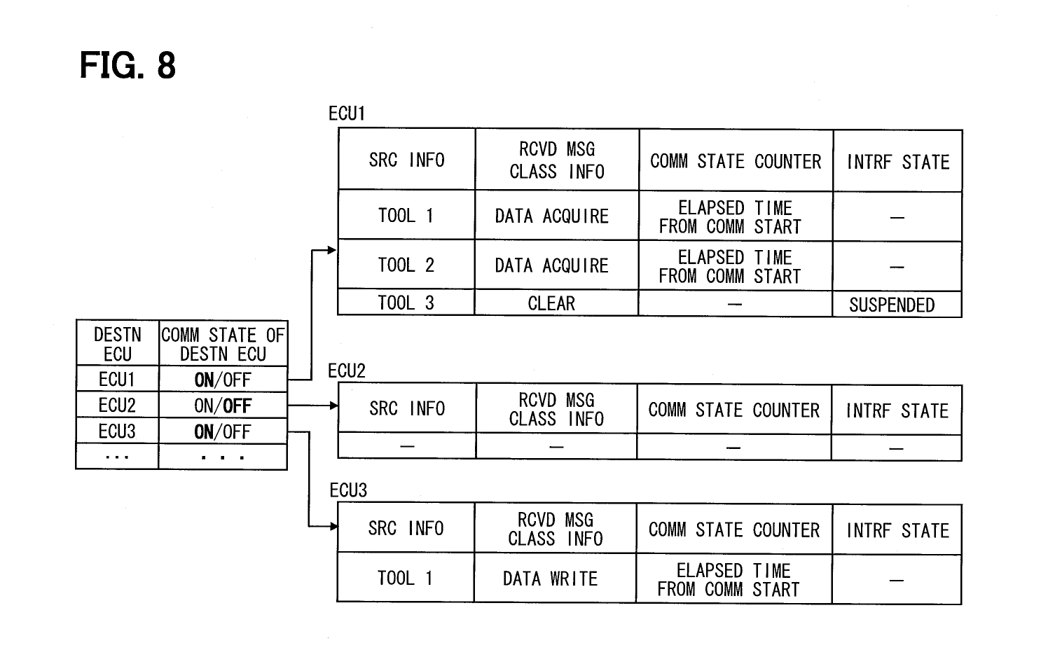

FIG. 8 illustrates an example of a structure of communication state information provided to implement the message suspend function of the present embodiment. In FIG. 8, an attribute indicative of an interference state of each tool 1-n is added to the communication state information, as compared with the communication state information illustrated in FIG. 4.

When it is determined that a later-received request message in combination with a previously-received request message dose not cause the interference of operations of a destination ECU 1-m, the DoIP gateway 101 sets nothing to the interference state. In this case, as in the first embodiment, the communication state information stores the source information indicative of the source of the later-received request message and the class information indicative of the class of the later-received request message, and the communication state counter starts counting an elapsed time.

When it is determined that the interference of operations of the destination ECU 1-m is caused, the DoIP gateway 101 retains the source information and the class information concerning the request message in the communication state information, and sets the interference state to a suspended state. In this case, the DoIP gateway 101 does not perform the gateway operation of forwarding the request message to the destination ECU 1-m but temporarily stores the request message in the DoIP gateway 101. Additionally, the communication state counter does not start counting the elapsed time.

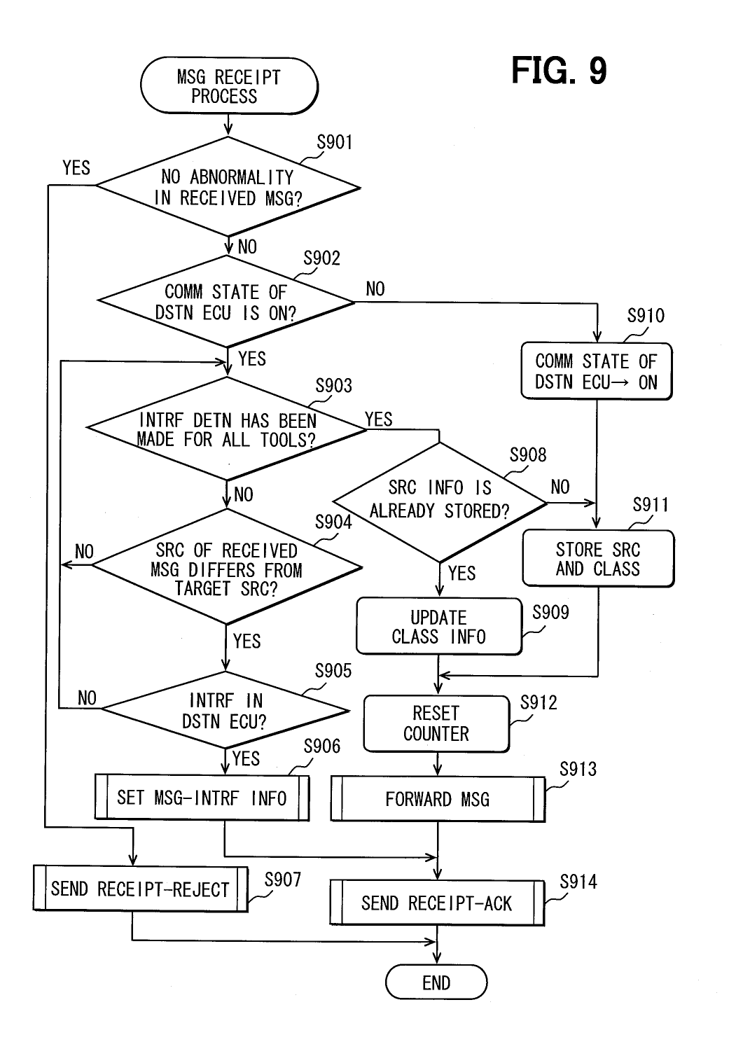

With reference to FIG. 9, a manner of implementing the message suspend function by using the communication state information illustrated in FIG. 8 will be illustrated. FIG. 9 is a flowchart illustrating an interference determination process. The DoIP gateway 101 performs the interference determination process upon receipt of a request message from a tool 1-n. Note that S901 to S905 in FIG. 9 are the same as S501 to S505 in FIG. 5. Thus, explanation on S901 to S905 is omitted.

When it is determined at S905 that the interference of operations of the destination ECU 1-m is not caused, the process proceeds to S906. At S906, a interference information setting process is performed on a later-received request message, and then the process proceeds to S914. At S914, an acknowledgment response message indicative of acknowledgement of receipt of the request message is transmitted. Since other steps in FIG. 9 are the same as those in FIG. 5, explanation on the other steps is not provided.

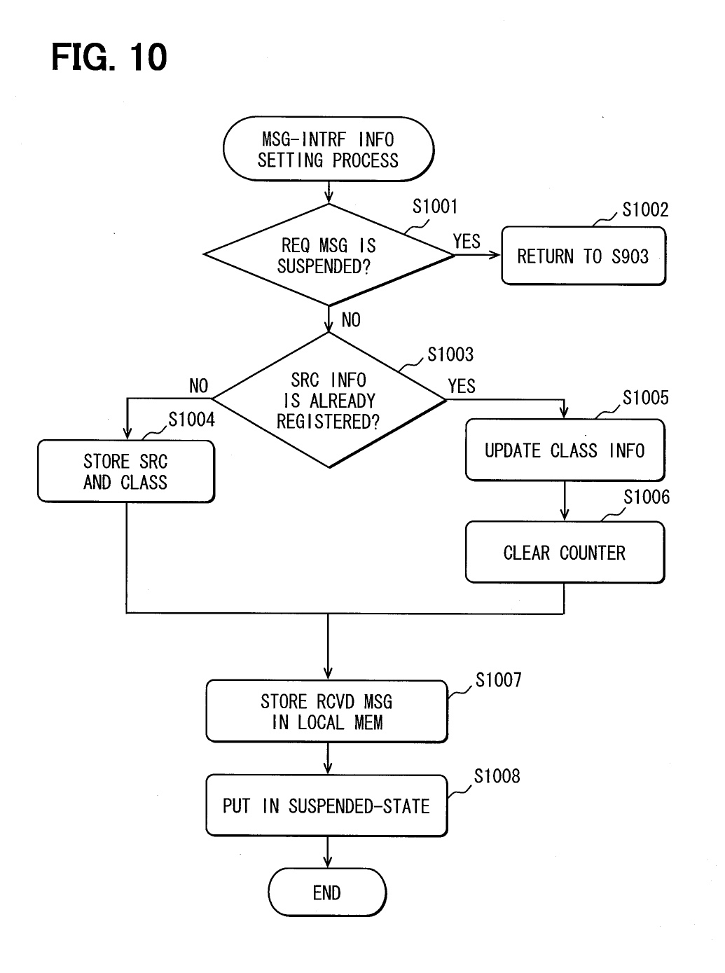

FIG. 10 is a flowchart illustrating details of the interference information setting process at S906 in FIG. 9.

At S1001, the DoIP gateway 101 determines whether a target request message is in the suspend state (transmission suspended state), by referring to the interference information of the target request message. In the above, the target request message is the request message that was registered in the communication state information and was used at S905 in FIG. 9 as a basis for determining that the interference of operations of the destination ECU 1-m is caused. When the target request message is in the transmission suspended state, the communication attributed to the target request message is not being executed, and thus, the forwarding of the present request message (the request message received this time) to the destination ECU 1-m does not cause the interference of operations. Therefore, when it is determined at S1001 that the target request message is in the transmission suspended state, the process returns to S903 in FIG. 9. When it is determined at S1001 that the target request message is not in the transmission suspended state and that the communication attributed to the target request message is being executed, the process proceeds to S1003.

At S1003, it is determined whether the source information indicative of the source of the received request message is already registered in the communication state information. That is, it is determined whether the received request message is the request message transmitted from a new tool 1-n whose source information is not stored in the communication state information. When it is determined at S1003 that the source information is already registered in the communication state information, the process proceeds to S1004. Then, the source information and the class information of the request message are newly stored in the communication state information. When it is determined at S1003 that the source information of the received request message is already registered, the flow proceeds to S1005.

At S1005, the message class information in the communication state information is updated with the class of the request message received this time. At S1006, the corresponding communication state counter is cleared and the counting operation of the corresponding communication state counter is kept stopping.

At S1007, the received request message is temporarily stored (retained) in a memory in the DoIP gateway 101. At S1008, the interference state of the communication state information is set to the suspended state.

In the above way, the source information, the received message class information, and the interference information concerning the request message are stored in the communication state information, where the request message is determined as a cause of the interference of operations of the destination ECU 1-m

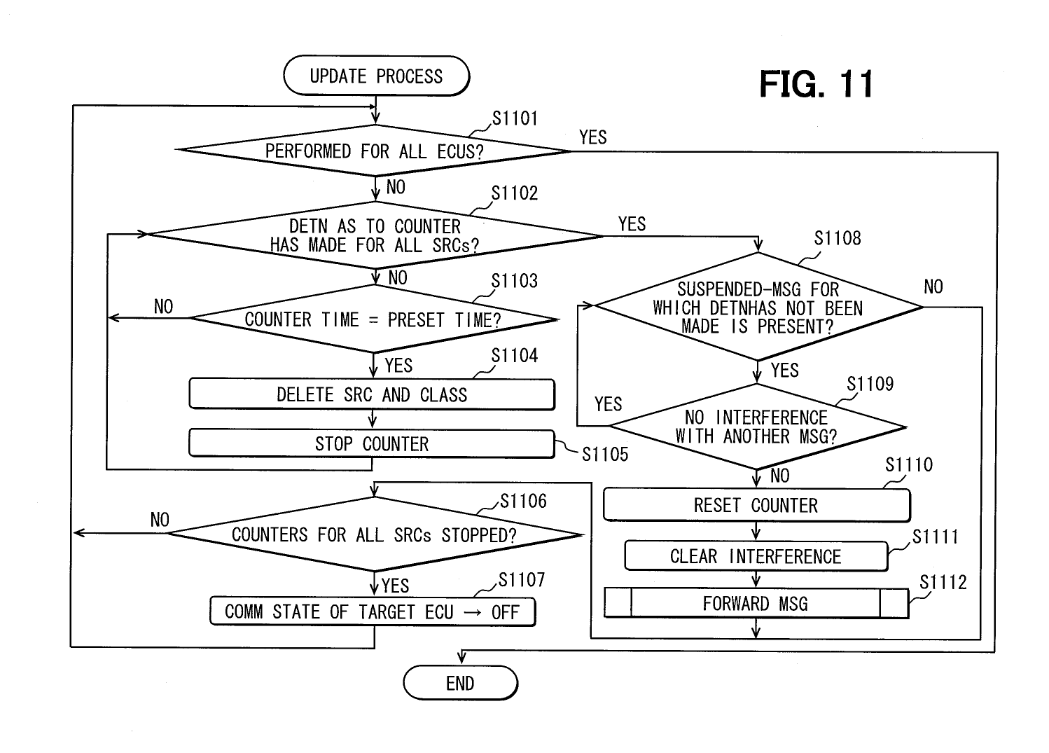

Next, with reference to FIG. 11, an update process for updating the communication state information will be described in accordance with the present embodiment. The update process is periodically performed. It should be noted that S1101 to S1107 in FIG. 11 are the same as S601-S607 in FIG. 6, and thus, the explanation on S1101 to S1107 is omitted.

The flowchart of FIG. 11 is different from the flowchart of FIG. 6 in that S1108 to S1112 are inserted between S1102 and S1106. S1108 to S1112 are provided, so that in cases where the forwarding of a certain request message is suspended, the suspended certain request message is forwarded to the destination ECU 1-m after the communication attributed to another request message determined as a cause of the interference of operations is ended.

When it is determined that the determination at S1102 has been made for all of the communication state counters of the communication state information of the target ECU 1-m, the DoIP gateway 101 performs S1108 to S1112. At this timing, for each tool 1-n, the determination as to whether the each tool 1-n is communicating or ends communicating has been already made based on the elapsed time counted by the communication state counter. Therefore, upon determining that the communication attributed to the request message determined as a cause of the interference of operations has ended, the DoIP gateway 101 can immediately transmits the transmission-suspended request message.

At S1108, by referring to the interference state in the communication state information of the target ECU 1-m, the DoIP gateway 101 determines whether a transmission-suspended request message is present. When the transmission-suspended request message is not present, S1109 to S1112 are skipped, so that the process directly proceeds to S1106. When the transmission-suspended request message is present, the process proceeds to S1109. At S1109, by referring to the communication state information, the DoIP gateway 101 determines whether a risk of an occurrence of the interference of operations is no longer present because of the end of the communication attributed to the request message that can cause the interference of operations, in combination with the transmission-suspended request message. When it is determined that the risk of occurrence of the interference of operations is present, the process returns to S1108 where it is determined whether the risk of occurrence of the interference of operations is no longer present, the process proceeds to S1110.

At S1110, the communication state counter corresponding to the transmission-suspended request message is reset and starts counting. At S1111, the suspended state of the communication state information is cleared. At S1112, the DoIP gateway 101 performs the gateway operation of forwarding the transmission-suspended to the destination ECU 1-m.

It should be noted that multiple messages cannot be transmitted to one ECU 1-m at the same time. Thus, after the forwarding of a certain transmission-suspended message is completed, the process proceeds to S1106 without making the determination as to the transmission-suspended state of the request message addressed to the ECU 1-m.

Although the embodiments have been illustrated in the above, embodiments are not limited to the above-illustrated embodiment and can various forms within the spirit and scope of the present disclosure.

For example, in the above embodiment, the communication state counter counts an elapsed time from the forwarding of a request message from a tool 1-n to an ECU 1-m. When the elapsed time reaches a predetermined time, the communication attributed to the request message is deemed ended.

In another embodiment, the DoIP gateway 101 may have a reading function to read content of a response message transmitted from the ECU 1-m toward the tool 1-n. The in-vehicle message reception section 208 may be provided with the reading function. Upon receipt of the request message from the tool 1-n, the ECU 1-m transmits an acknowledgment response message indicating that the ECU 1-m responds to the request message. The DoIP gateway 101 forwards this acknowledgment response message to the tool 1-n, and causes the communication state counter to start counting an elapsed time from the forwarding of the acknowledgment response message to the tool 1-n. In this configuration, when the elapsed time counted by the communication state counter reaches a predetermined time and the DoIP gateway 101 does not receive a new message from the tool 1-n during the predetermined time, the communication attributed the request message can be deemed ended.

When the response message transmitted from the ECU 1-m in response to the request message from the tool 1-n is a negative-acknowledgement response, the DoIP gateway 101 may delete (i) the source information, which indicates the tools 1-n as a source of the request message, and (ii) the class information, which indicates the class of the request message, from the communication state information, and may stop counting with the communication state counter.

At a time when the DoIP gateway 101 forwards the request message from the tool 1-n to the ECU 1-m, the DoIP gateway 101 already has the source information indicative of the tool 1-n and the class information indicative of the class of the forwarded request message, and has already started counting with the communication state counter. In this situation, when the ECU 1-m, which has received the request message, transmits the negative-acknowledgement response message, the communication between the tool 1-n and the ECU 1-m is ended at a time of the transmitting of the negative-acknowledgement response message. Therefore, it may be preferable that when the response message from the ECU 1-m is a negative-acknowledgement response, the DoIP gateway deem the communication ended and execute the above processing. Accordingly, only correct information is stored as the communication state information, so that there is no influence on a subsequent request message.

It should be noted that when a predetermined condition is satisfied, the ECU 1-m transmits the negative-acknowledgement response message to the tool 1-n to notify the tool 1-n that the request message is rejected. The predetermined condition is, for example, that: (i) the ECU 1-m receives the request message having the class that is not supported by the ECU 1-m; (ii) the ECU 1-m cannot recognize content of the request message due to an error of the contents of the request message or the like; (iii) without execution of the above session transition, the tool 1-n transmits the request message that is out of the limited range; or the like.

According the above embodiments, S512 and S1112 performed by the gateway processor 205 can correspond to a forwarding means or a forwarding section. S510, S911, S604, S1104 performed by the gateway processor 205 can correspond to a storing means and a storing section. S505, S905 performed by the gateway processor 205 can correspond to an interference determination means and an interference determination section. S506 performed by the gateway processor 205 can correspond to a negative-acknowledgement response means and a negative-acknowledgement response section. S1007 performed by the gateway processor 205 can correspond to a retaining means and a retaining section. The in-vehicle message reception section 208 can correspond to a reading means or a reading section. The interference definition information storage 213 can correspond to a definition information storing means or a definition information storing section.

In the present disclosure, a vehicular communication control apparatus may be interposed, for relaying messages, between an Internet-protocol-based network and an in-vehicle local area network in order to enable transmission and reception of the messages between external tools connected to the Internet-protocol-based network and an in-vehicle electronic control unit (ECU) connected to the in-vehicle local area network. Such a vehicular communication control apparatus may be configured in various ways. For example, according to a first example, the vehicular communication control apparatus may comprise a forwarding section (forwarding means), a storing section (storing means), and an interference determination section (interference determination section means). The forwarding section is provided to forward the messages to the in-vehicle ECU that is to receive the messages, upon receipt of the messages from the external tools including a first external tool and a second external tool provided separately from each other. The storing section is provided store a class of a message from the first external tool when the forwarding section forwards the message from the first external tool to the in-vehicle ECU. The storing section stores the class of the message from the first external tool until communication, which is between the first external tool and the in-vehicle ECU and is attributed to the message from the first external tool, is ended. When the vehicular communication control apparatus receives a message addressed to the in-vehicle ECU from the second external tool while the in-vehicle ECU is communicating with the first external tool, the interference determination section makes a determination as to whether or not an interference of operations of the in-vehicle ECU is caused by the message from the second external tool and the message whose class is stored by the storing section, based on a class of the message from the second external tool and the class of the message stored by the storing section. When the interference determination section determines that the interference of operations of the in-vehicle ECU is not caused, the forwarding section forwards the message from the second external tool to the in-vehicle ECU.

According to the above vehicular communication control apparatus, when the message from the first external tool is received and forwarded to the in-vehicle ECU and the communication is started, the class of the forwarded message is stored by the storing section until the communication is ended. Because of this, upon receipt of a massage addressed to the same in-vehicle ECU from the second external tool after the receipt of the message from the first external tool, the interference determination section can determine whether the interference of operations of the in-vehicle ECU is caused by both of the messages. When it is determined that the interference of operations of the in-vehicle ECU is not caused, the forwarding section can forward the message from the second external tool to the in-vehicle ECU. Therefore, it becomes possible to prevent the interference of operations of the in-vehicle ECU. Moreover, when the in-vehicle ECU is communicating with a certain tool for example, a message from a different tool 1-n is transmitted to the ECU as long as the transmission of the message from the different tool does not cause the interference of operations of the destination ECU. Therefore, the communications between the external tools and the in-vehicle ECU are efficient, as compared with cases where: when the in-vehicle ECU 1-m is communicating with a certain tool, the transmitting of a request message from a different tool is uniformly prohibited.

According to a second example, the vehicular communication control apparatus may further comprise a negative-acknowledgement response section (negative-acknowledgement response section means) that, when the interference determination section determines that the interference of operations of the in-vehicle ECU is caused, transmits a response message to the second external tool to indicate that receipt of the message from the second external tool is rejected.

According to the configuration of the second example, an operator can understand that reception of the message from the second external tool was rejected. Therefore, for example, after the communication with a different external tool is ended, the operator can instruct the second external tool to again transmit the same message.

According to a third example, the vehicular communication control apparatus may further comprise a retaining section (retaining means) that retains the message from the second external when the interference determination section determines that the interference of operations of the in-vehicle ECU is caused. The forwarding section may forward the message retained by the retaining section to the in-vehicle ECU when: (i) the communication attributed to the message from the first external tool, which causes the interference of operations of the in-vehicle ECU in combination with the message retained by the retaining section, is ended; and (ii) the interference determination section changes a result of the determination and determines that the interference of operations of the in-vehicle ECU is not caused.

According to the configuration of the third example, when the interference of operations of the in-vehicle ECU is not caused, the message from the second external tool is automatically transmitted to the in-vehicle ECU. As a result, a time and effort for the second external tool to again transmit the same message can be eliminated.

According to a fourth example, the vehicular communication control apparatus may be configured as follows. The external tools further include a third external tool different from the first external tool and the second external tool. When a predetermined condition is satisfied, the forwarding section forwards a message from the third external tool to the in-vehicle ECU even if the interference of the operations of the in-vehicle ECU is caused by the message from the third external tool and the message from the second external tool retained by the retaining section. The predetermined condition is that upon receipt of the message from the third external tool in a situation in which the in-vehicle ECU is communicating with the first external tool and the retaining section is retaining the message from the second external tool, the interference determination section determines that the interference of operations of the in-vehicle ECU is not caused by the message from the third external tool and the message from the first external tool communicating with the in-vehicle ECU.

A reason for employing this configuration is that when the forwarding of the message from the second external tool to the in-vehicle ECU is suspended, the forwarding of the message from the third external tool to the in-vehicle ECU does not cause the interference of operations of the in-vehicle ECU.

According to a fifth example, the vehicular communication control apparatus may be configured as follows. The storing section deletes the stored class of the massage by deeming that the communication attributed to the message from the first external tool is ended, when (i) a predetermined time has elapsed since the message from the first external tool was forwarded to the in-vehicle ECU and (ii) there has been no receipt of a new message from the first external tool during the predetermine time.

According to the configuration of the fifth example, the stored class of the message is deleted in the above way. Therefore, upon receipt of a new message, the vehicular communication control apparatus can e quickly forward the new message to the in-vehicle ECU.

According to a sixth example, the vehicular communication control apparatus may be configured as follows. Upon receipt of a response message, which is a response to the message forwarded to the in-vehicle ECU and which is addressed to the first external tool, from the in-vehicle ECU, the forwarding section forwards the response message to the first external tool. The vehicular communication control apparatus may comprise a reading section (reading means) for reading content of the response message from the in-vehicle ECU. When the read content of the response message is a negative-acknowledgement response indicating that the in-vehicle ECU does not respond to the message from the first external tool, the storing section deletes the stored class of the message.

A reason for employing this configuration is that when the negative-acknowledgement response message is transmitted from the in-vehicle ECU, the communication between the in-vehicle ECU and the first external tool can be deemed ended.

According to a seventh example, the vehicular communication control apparatus may be configured as follows. Upon receipt of a response message, which is a response to the message forwarded to the in-vehicle ECU and is addressed to the first external tool, from the in-vehicle ECU, the forwarding section forwards the response message to the first external tool. The vehicular communication control apparatus may further comprise a reading section (reading means) for reading content of the response message from the in-vehicle ECU. The storing section deletes the stored class of the message by deeming that the communication attributed to the message from the first external tool is ended, when: (i) the read content of the response message is an acknowledgment response indicating that the in-vehicle ECU responds to the message from the first external tool; (ii) a predetermined time has elapsed since the response message was forwarded by the forwarding section; and (iii) there has been no receipt of a new message from the first external tool during the predetermined period.

As can be seen, it may be preferable to set a stating time of the predetermined time to a time when the response message from the in-vehicle ECU is forwarded to the first external tool.

According to an eighth example, the vehicular communication control apparatus may be configured as follows. When the vehicular communication control apparatus receives from the first external tool a new message whose class is different from the class stored by the storing section, the storing section (i) deems that the communication attributed to the message whose class is stored is ended, and (ii) replaces the stored class of the message with the class of the new message.

A reason for employing this configuration is that when a message whose class is different from the stored class is received from the first external tool, the communication attributed to the class of the received message starts.

According to a ninth example, the vehicular communication control apparatus may further comprise a definition information storing section (definition information storing means) for storing definition information describing a predefined combination of classes of messages that causes the interference of operations of the in-vehicle ECU. By referring to the definition information, the interference determination section determines whether the interference of operations of the in-vehicle ECU is caused.

A reason for employing this configuration is that since classes of messages exchanged between the external tools and the in-vehicle apparatus is known in advance, it can be determined in advance which combination of classes of messages causes the interference of operations of the in-vehicle ECU.

What is claimed is:

1. A vehicular communication control apparatus that is interposed, for relaying messages, between an Internet-protocol-based network and an in-vehicle local area network in order to enable transmission and reception of the messages between external tools connected to the Internet-protocol-based network and an in-vehicle electronic control unit connected to the in-vehicle local area network, the vehicular communication control apparatus comprising:
a forwarding section for, upon receipt of the messages from the external tools, forwarding the messages to the in-vehicle electronic control unit that is to receive the messages, wherein the external tools include a first external tool and a second external tool provided separately from each other;
a storing section for storing a class of a message from the first external tool when the forwarding section forwards the message from the first external tool to the in-vehicle electronic control unit, wherein the storing section stores the class of the message from the first external tool until communication, which is between the first external tool and the in-vehicle electronic control unit and is attributed to the message from the first external tool, is ended; and
an interference determination section for, when the vehicular communication control apparatus receives a message addressed to the in-vehicle electronic control unit from the second external tool while the in-vehicle electronic control unit is communicating with the first external tool,
making a determination as to whether or not an interference of operations of the in-vehicle electronic control unit is caused by the message from the second external tool and the message whose class is stored by the storing section, based on a class of the message from the second external tool and the class of the message stored by the storing section,
wherein:
when the interference determination section determines that the interference of operations of the in-vehicle electronic control unit is not caused, the forwarding section forwards the message from the second external tool to the in-vehicle electronic control unit.

2. The vehicular communication control apparatus according to claim 1, further comprising:
a negative-acknowledgement response section for, when the interference determination section determines that the interference of operations of the in-vehicle electronic control unit is caused,
transmitting a response message to the second external tool, wherein the response message indicates that receipt of the message from the second external tool is rejected.

3. The vehicular communication control apparatus according to claim 1, further comprising:
a retaining section for retaining the message from the second external when the interference determination section determines that the interference of operations of the in-vehicle electronic control unit is caused,
wherein:
the forwarding section forwards the message retained by the retaining section to the in-vehicle electronic control unit when:
the communication attributed to the message from the first external tool, which causes the interference of operations of the in-vehicle electronic control unit in combination with the message retained by the retaining section, is ended; and
the interference determination section changes a result of the determination and determines that the interference of operations of the in-vehicle electronic control unit is not caused.

4. The vehicular communication control apparatus according to claim 3, wherein:
the external tools further include a third external tool provided separately from the first external tool and the second external tool;
when a predetermined condition is satisfied, the forwarding section forwards a message from the third external tool to the in-vehicle electronic control unit even if the interference of the operations of the in-vehicle electronic control unit is caused by the message from the third external tool and the message from the second external tool retained by the retaining section; and
the predetermined condition is that
upon receipt of the message from the third external tool in a situation in which the in-vehicle electronic control unit is communicating with the first external tool and the retaining section is retaining the message from the second external tool, the interference determination section determines that the interference of operations of the in-vehicle electronic control unit is not caused by the message from the third external tool and the message from the first external tool communicating with the in-vehicle electronic control unit.

5. The vehicular communication control apparatus according to claim 1, wherein:
the storing section deletes the stored class of the massage by deeming that the communication attributed to the message from the first external tool is ended, when:
a predetermined time has elapsed since the message from the first external tool was forwarded to the in-vehicle electronic control unit; and
there has been no receipt of a new message from the first external tool during the predetermine time.

6. The vehicular communication control apparatus according to claim 5, wherein:
upon receipt of a response message, which is a response to the message forwarded to the in-vehicle electronic control unit and is addressed to the first external tool, from the in-vehicle electronic control unit, the forwarding section forwards the response message to the first external tool,
the vehicular communication control apparatus further comprising:
a reading section for reading content of the response message from the in-vehicle electronic control unit,
wherein:
when the read content of the response message is a negative-acknowledgement response indicating that the in-vehicle electronic control unit does not respond to the message from the first external tool, the storing section deletes the stored class of the message.

7. The vehicular communication control apparatus according to claim 1, wherein
upon receipt of a response message, which is a response to the message forwarded to the in-vehicle electronic control unit and is addressed to the first external tool, from the in-vehicle electronic control unit, the forwarding section forwards the response message to the first external tool,
the vehicular communication control apparatus further comprising:
a reading section for reading content of the response message from the in-vehicle electronic control unit,
wherein:
the storing section deletes the stored class of the message by deeming that the communication attributed to the message from the first external tool is ended, when:
the read content of the response message is an acknowledgment response indicating that the in-vehicle electronic control unit responds to the message from the first external tool;
a predetermined time has elapsed since the response message was forwarded by the forwarding section; and
there has been no receipt of a new message from the first external tool during the predetermined period.

8. The vehicular communication control apparatus according to claim 1, wherein:
when the vehicular communication control apparatus receives from the first external tool a new message whose class is different from the class stored by the storing section, the storing section deems that the communication attributed to the message whose class is stored is ended, and replaces the stored class of the message with the class of the new message.

9. The vehicular communication control apparatus according to claim 1, further comprising:
a definition information storing section for storing definition information describing a predefined combination of classes of messages that causes the interference of operations of the in-vehicle electronic control unit,
wherein:
by referring to the definition information, the interference determination section determines whether the interference of operations of the in-vehicle electronic control unit is caused.
